(19) United States
(12) Patent Application Publication
(10) Pub. No.: US 2015/0062079 A1
(43) Pub. Date: Mar. 5, 2015

(54) METHOD OF LOCATING A TOUCH POINT AND SENSING A TOUCH PRESSURE ON A TOUCH DEVICE

(71) Applicant: TIANJIN FUNAYUANCHUANG TECHNOLOGY CO.,LTD., Tianjin (CN)

(72) Inventors: PO-SHENG SHIH, New Taipei (TW); CHIEN-YUNG CHENG, New Taipei (TW); CHIH-HAN CHAO, New Taipei (TW); JIA-SHYONG CHENG, New Taipei (TW)

(21) Appl. No.: 14/467,064

(22) Filed: Aug. 25, 2014

(30) Foreign Application Priority Data
Aug. 30, 2013 (CN) 2013103871813

(51) Int. Cl. G06F 3/044; G06F 3/045

(52) U.S. Cl. CPC G06F 3/044; G06F 3/045
USPC 345/174

(57) ABSTRACT

A method of locating a touch point and touch pressure on a touch device includes following steps. A number of first values C₁ are obtained by driving and sensing a number of driving and sensing electrodes one by one, wherein the driving and sensing electrodes which are not sensed are grounded. A number of second values C₂ are obtained by driving and sensing the number of driving and sensing electrodes one by one again, and the driving and sensing electrodes which are not sensed are grounded. Whether there is touch pressure on the touch device is determined by comparing the first value C₁ and the second value C₂.

### CROSS-REFERENCE TO RELATED APPLICATIONS

This application claims all benefits accruing under 35 U.S.C. §119 from China Patent Application No. 201310387181.3, filed on Aug. 30, 2013, in the China Intellectual Property Office, the disclosure of which is incorporated herein by reference.

### BACKGROUND

1. Technical Field

The present disclosure relates to a method of locating a touch point and sensing a touch pressure on a touch panel, particularly on a capacitive touch panel.

2. Description of Related Art

Conventional touch panels detect contact areas between the touch conductors and the capacitive touch panels to reflect the pressure on the contact areas. However, if hard touch conductors are used, the contact areas may be constant regardless of the amount of the force applied on the touch panels. Therefore, the pressure may not be measured accurately, and may trigger errors in operating the touch panels.

What is needed, therefore, is to provide sensing methods for solving the problem discussed above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic cross-sectional side view of an embodiment of a capacitive touch device.

FIG. 2 is an exploded view of the capacitive touch device.

FIG. 3 shows a schematic view of a driving and a sensing circuit in one embodiment of the capacitive touch device.

FIG. 4 is a flowchart of an embodiment of a method of locating a touch point and sensing a touch pressure on the capacitive touch device.

FIG. 5 is a schematic view of a simulation curves of the method of locating a touch point and sensing a touch pressure of FIG. 4.

FIG. 6 is a flowchart of another embodiment of a method of locating a touch point and sensing a touch pressure on the capacitive touch device.

FIG. 7 is a schematic view of a simulation curves of the method of locating a touch point and sensing a touch pressure of FIG. 6.

FIG. 8 is a flowchart of yet another one embodiment of a method of locating a touch point and sensing a touch pressure on the capacitive touch device.

FIG. 9 is a flowchart of yet another one embodiment of a method of locating a touch point and sensing a touch pressure on the capacitive touch device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

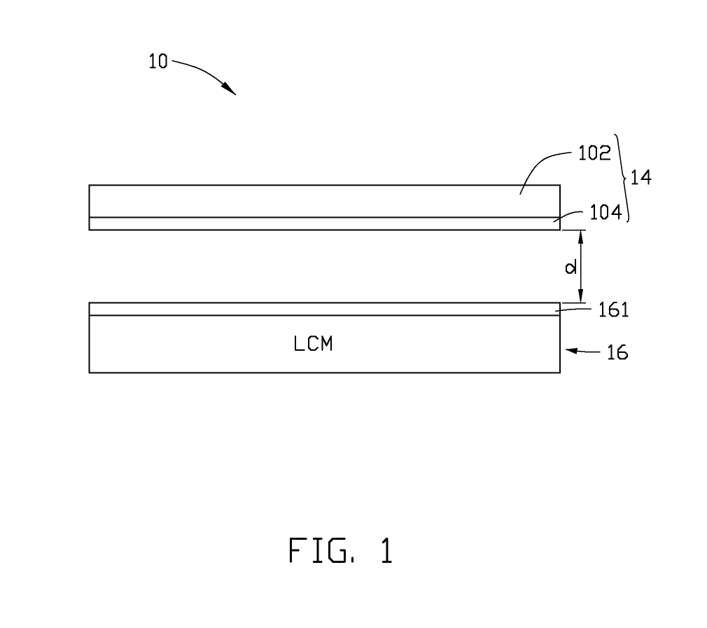

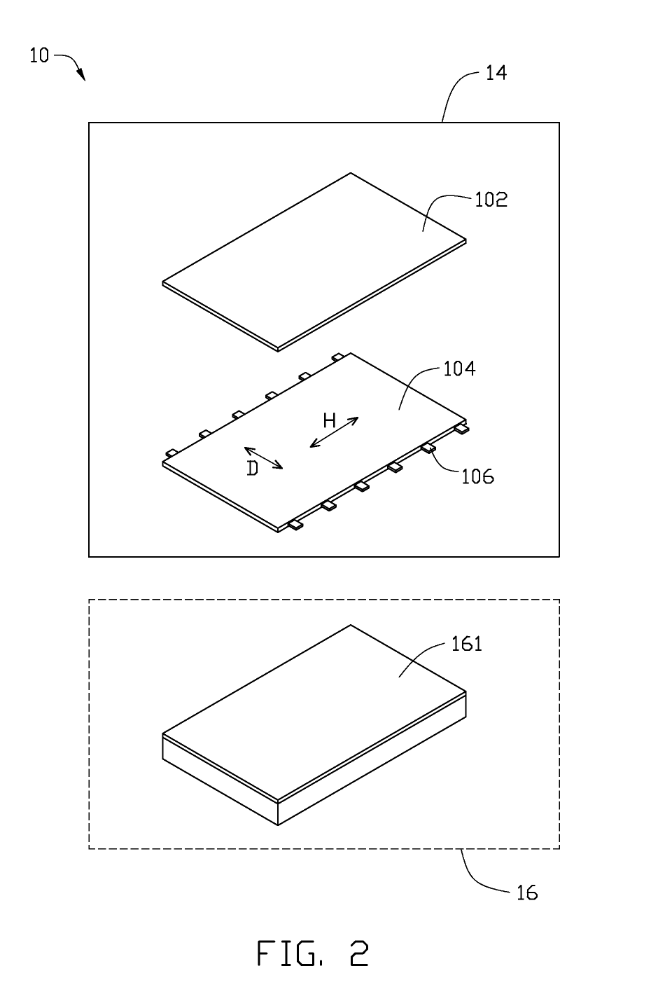

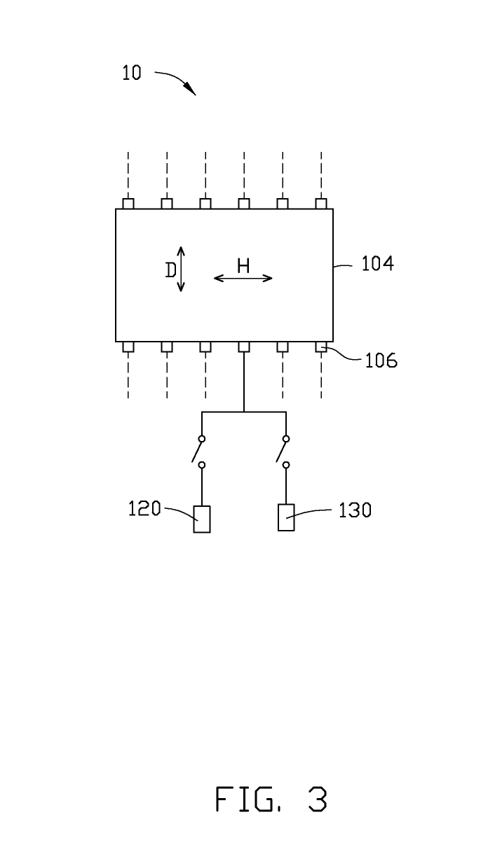

Referring to FIGS. 1-3, a method of locating a touch point and sensing a touch pressure on a touch device 10 is provided. The touch device 10 includes a touch module 14 and a display module 16 spaced from each other.

The touch module 14 can be spaced from the display module 16 via a supporter or an insulating layer (not shown). The touch module 14 includes a substrate 102 and a first conductive film 104 on the substrate 102. The first conductive film 104 is located on a first surface of the substrate 102 adjacent to the display module 16. Furthermore, the first conductive film 104 can be transparent.

In one embodiment, the touch module 14 consists of the substrate 102, the conductive film 104, and the plurality of driving and sensing electrodes 106.

The substrate 102 can be made of a flexible and transparent material. The material can be polyethylene, polycarbonate, polyethylene terephthalate, polyethylene terephthalate, polymethyl, or methacrylate.

The first conductive film 104 can be electrically anisotropic defining a low electrical impedance in a direction D and a high electrical impedance in a direction H. The plurality of first driving and sensing electrodes 106 are located on at least one of two opposite sides of the substrate 102 along the low impedance direction D. Each of the plurality of first driving and sensing electrodes 106 is electrically connected to a driving integrated circuit 120 and a sensing integrated circuit 130. The driving integrated circuit 120 is configured to provide driving signals to the plurality of driving and sensing electrodes 106. The sensing integrated circuit 130 is configured to read the signal values from the plurality of driving and sensing electrodes 106.

The electrical conductivity of the anisotropic impedance layer on the relatively high impedance direction H is smaller than the electrical conductivities of the anisotropic impedance layer in other directions. The electrical conductivity of the anisotropic impedance layer on the relatively low impedance direction D is larger than the electrical conductivities of the anisotropic impedance layer in other directions. The relatively high impedance direction H is different from the relatively low impedance direction D. In one embodiment, the relatively high impedance direction H is substantially perpendicular to the relatively low impedance direction D. The relatively high impedance direction H and the relatively low impedance direction D of the anisotropic impedance layer can be achieved by having a plurality of conductive belts having a low conductivity aligned along the relatively high impedance direction H and a plurality of conductive belts having a high conductivity aligned along the relatively low impedance direction D, and the plurality of conductive belts having the low conductivity and the plurality of conductive belts having the low conductivity are electrically connected with each other. In another embodiment, the relatively high impedance direction H and the relatively low impedance direction D of the anisotropic impedance layer can be achieved by having a carbon nanotube film comprising orderly arranged carbon nanotubes. The first conductive film 104 can have a square shape having two sides substantially perpendicular to the relatively high impedance direction H and two sides substantially perpendicular to the relatively low impedance direction D. The anisotropic impedance layer with the continuous conductivity can generate a leakage current to achieve precise touch detection.

A material of the first conductive film 104 can be at least one of carbon nanotubes, indium tin oxide, metal, and graphene. The first conductive film 104 can be a mesh which is transparent, electrical anisotropic, and made of the carbon nanotubes, indium tin oxide, metal, graphene, or combinations thereof.

The conductive film 104 can include a carbon nanotube film, and the carbon nanotube film can be drawn from a carbon nanotube array. The carbon nanotube film comprises a plurality of carbon nanotubes orderly arranged. The plurality of carbon nanotubes are substantially aligned along a same direction so that the carbon nanotube film has a maximum electrical conductivity at the aligned direction of the carbon nanotubes which is greater than at other directions. The aligned direction of the plurality of carbon nanotubes is the relatively low impedance direction D. The carbon nanotube film can be formed by drawing the film from a carbon nanotube array. The overall aligned direction of a majority of the carbon nanotubes in the carbon nanotube film is substantially aligned along the same direction and substantially parallel to a surface of the carbon nanotube film. The carbon nanotube is joined to adjacent carbon nanotubes end to end by van der Waals force therebetween, and the carbon nanotube film is capable of being a free-standing structure. A support having a large surface area to support the entire free-standing carbon nanotube film is not necessary, and only a supportive force at opposite sides of the film is sufficient. The free-standing carbon nanotube film can be suspended and maintain its film state with only supports at the opposite sides of the film. When disposing (or fixing) the carbon nanotube film between two spaced supports, the carbon nanotube film between the two supports can be suspended while maintaining its integrity. The successively and aligned carbon nanotubes joined end to end by van der Waals attractive force in the carbon nanotube film is one main reason for the free-standing property. The carbon nanotube film drawn from the carbon nanotube array has good transparency. In one embodiment, the carbon nanotube film is substantially a pure film and consists essentially of the carbon nanotubes, and to increase the transparency of the touch panel, the carbon nanotubes are not functionalized.

The plurality of carbon nanotubes in the carbon nanotube film have a preferred orientation along the same direction. The preferred orientation means that the overall aligned direction of the majority of carbon nanotubes in the carbon nanotube film is substantially along the same direction. The overall aligned direction of the majority of carbon nanotubes is substantially parallel to the surface of the carbon nanotube film, thus parallel to the surface of the polarizing layer. Furthermore, the majority of carbon nanotubes are joined end to end therebetween by van der Waals force. In this embodiment, the majority of carbon nanotubes are substantially aligned along the same direction in the carbon nanotube film, with each carbon nanotube joined to adjacent carbon nanotubes at the aligned direction of the carbon nanotubes end to end by van der Waals force. There may be a minority of carbon nanotubes in the carbon nanotube film that are randomly aligned, but the number of randomly aligned carbon nanotubes is small compared to the majority of substantially aligned carbon nanotubes and therefore will not affect the overall oriented alignment of the majority of carbon nanotubes in the carbon nanotube film.

In the carbon nanotube film, the majority of carbon nanotubes that are substantially aligned along the same direction may not be completely straight. Sometimes, the carbon nanotubes can be curved or not exactly aligned along the overall aligned direction, and can deviate from the overall aligned direction by a certain degree. Therefore, it cannot be excluded that partial contacts may exist between the juxtaposed carbon nanotubes in the majority of carbon nanotubes aligned along the same direction in the carbon nanotube film. Despite having curved portions, the overall alignment of the majority of the carbon nanotubes are substantially aligned along the same direction.

The carbon nanotube film includes a plurality of successive and oriented carbon nanotube segments. The plurality of carbon nanotube segments are joined end to end by van der Waals attractive force. Each carbon nanotube segment includes a plurality of carbon nanotubes that are substantially parallel to each other, and the plurality of parallel carbon nanotubes are in contact with each other and combined by van der Waals attractive force therebetween. The carbon nanotube segment can have a desired length, thickness, uniformity, and shape. The carbon nanotubes in the carbon nanotube film have a preferred orientation along the same direction. The carbon nanotube wires in the carbon nanotube film can consist of a plurality of carbon nanotubes joined end to end. The adjacent and juxtaposed carbon nanotube wires can be connected by the randomly aligned carbon nanotubes. There can be clearances between adjacent and juxtaposed carbon nanotubes in the carbon nanotube film. A thickness of the carbon nanotube film at the thickest location is about 0.5 nanometers to about 100 microns (e.g., in a range from 0.5 nanometers to about 10 microns).

The carbon nanotube film has a unique impedance property because the carbon nanotube film has a minimum electrical impedance in the drawing direction, and a maximum electrical impedance in the direction substantially perpendicular to the drawing direction, thus the carbon nanotube film has an anisotropic impedance property. A relatively low impedance direction D is the direction substantially parallel to the aligned direction of the carbon nanotubes, and a relatively high impedance direction H is substantially perpendicular to the aligned direction of the carbon nanotubes. The carbon nanotube film can have a square shape with four sides. Two sides are opposite to each other and substantially parallel to the relatively high impedance direction H. The other two sides are opposite to each other and substantially parallel to the relatively low impedance direction D. In one embodiment, a ratio between the impedance at the relatively high impedance direction H and the impedance at the relatively low impedance direction D of the carbon nanotube film is equal to or greater than 50 (e.g., in a range from 70 to 500).

Furthermore, a transparent protective film (not shown) can be located on the first conductive film 104. A material of the transparent protective film can be silicon nitride, silicon oxide, styrene cyclobutene (BCB), acrylic resin, polyester or the like material. The transparent protective film can also be polyethylene terephthalate (PET) film for protecting the first conductive film 104.

Furthermore, the touch module 14 can include another conductive film (not shown) located on a second surface of the substrate 102 opposites to the first surface. The conductive film on the second surface of the substrate 102 can be ITO. The two conductive films forms a capacitive touch sensor.

The display module 16 includes a second conductive film 161 spaced from the first conductive film 104. The second conductive film 161 functions as an electrode of the display module 16 adjacent to the touch module 14. Because the display module 16 is spaced from the touch module 14, the second conductive film 161 is spaced from the first conductive film 104. The first conductive film 104 and the second conductive film 161 forma capacitive touch sensor and function as a touch pressure sensing unit. In one embodiment, the display module 16 is a liquid crystal module (LCM).

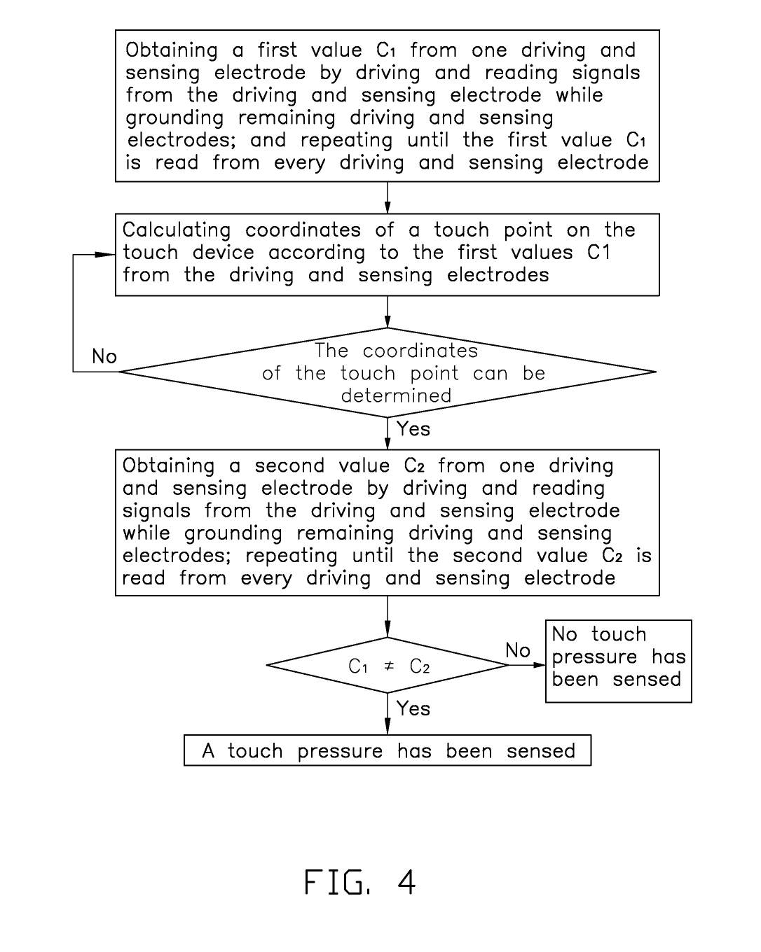

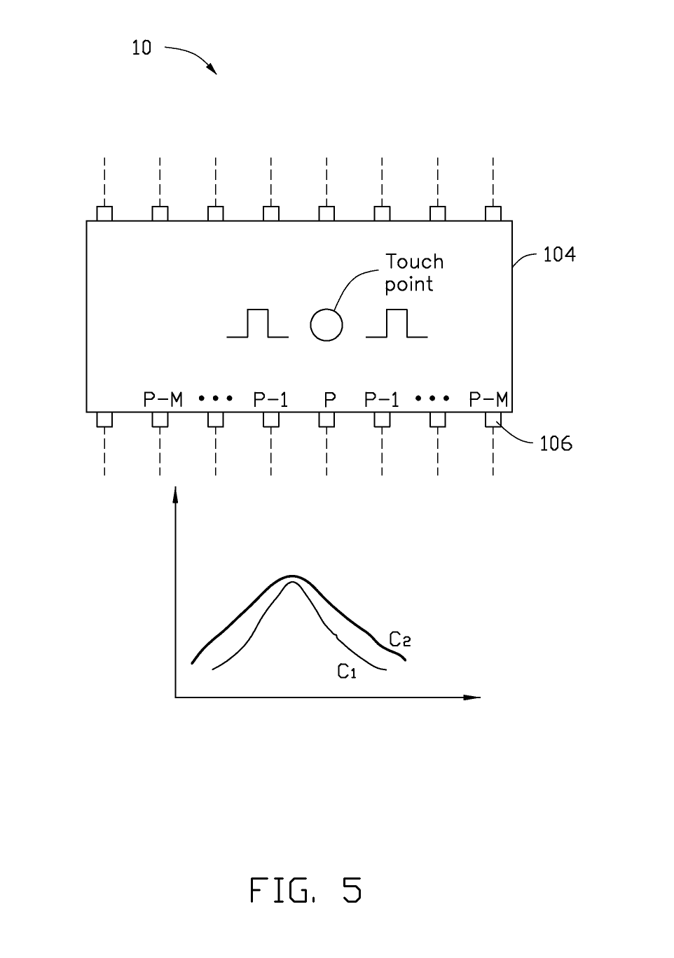

Referring to FIGS. 4-5, a method of sensing the touch point and sensing a touch pressure of the touch device 10 includes following steps:

(S11), obtaining a first value C₁ from one driving and sensing electrode 106 by driving and reading signals from the driving and sensing electrode 106 while grounding remaining driving and sensing electrodes 106, and repeating until the first value C₁ is read from every driving and sensing electrode 106;

(S12), obtaining a second value C₂ from one driving and sensing electrode 106 by driving and reading signals from the driving and sensing electrode while grounding remaining driving and sensing electrodes, and repeating until the second value C₂ is read from every driving and sensing electrode 106; and

(S13), determining whether there is touch pressure by comparing the first value C₁ and the second value C₂.

In step (S11), the touch point on the touch device 10 is obtained by calculating the first values C₁ of the plurality of driving and sensing electrodes 106. The first values C₁ can be obtained by driving and sensing the plurality of driving and sensing electrodes 106 one by one through the driving integrated circuit 120 and sensing integrated circuit 130.

In one embodiment, the plurality of driving and sensing electrodes 106 are located on single side of the substrate 102. In one embodiment, the plurality of driving and sensing electrodes 106 are located on the two opposite sides of the substrate 102. The first values C₁ can be obtained by driving the plurality of the driving and sensing electrodes 106 one by one on a first side of the substrate 102, and sensing the plurality of the driving and sensing electrodes 106 on a second side opposite to the first side of the substrate 102.

In one embodiment, the plurality of first values C₁ can be capacity values sensed through the plurality of driving and sensing electrodes 106.

In step (S12), the second values C₂ are obtained by driving and sensing the plurality of driving and sensing electrodes 106 again. In one embodiment, the second values C₂ are capacity values detected through the plurality of driving and sensing electrodes 106. In one embodiment, each one driving and sensing electrode 106 is driven, and while remaining of the driving and sensing electrodes 106 are grounded until every one of the driving and sensing electrodes are driven. The second values C₂ are obtained via the sensing integrated circuit 130.

In step (S13), the touch pressure can be detected by comparing the second values C₂ with the first values C₁ of each of the plurality of driving and sensing electrodes 106 one to one. When no touch pressure is applied on the touch module 14, the distance between the first conductive film 104 and the second conductive film 161 may be unchanged, and the second values C₂ may be equal to the first values C₁. When a touch pressure is applied on the touch module 14, and the distance between the first conductive film 104 and the second conductive film 161 near the touch point is reduced. Since the second conductive film 161 is grounded or driven by a direct current voltage, the capacity of the first conductive film 104 is affected by the second conductive film 161. Therefore, the second values C₂ may be greater than the first values C₁. The greater the touch pressure, the smaller the distance, and greater the differences between the second values C₂ and the first values C₁.

Furthermore, because the first conductive film 104 has impedance, current leakage occurs in the first conductive film 104 adjacent to the touch point. Thus touch pressure can be detected by comparing the second values C₂ with the first values C₁ obtained through some of the plurality of driving and sensing electrodes 106 near the touch point. As a result, an accuracy of the detecting touch pressure can be improved.

In one embodiment, the driving and sensing electrode 106 nearest to the touch point is numbered as a P electrode. The driving and sensing electrodes 106 number M electrodes away from the P electrode, wherein M<N/2, and N is a total of the plurality of driving and sensing electrodes 106 can be selected to be sensed to determine the touch pressure. For example, if M=2, the touch pressure can be detected by comparing the second values C₂ and the first values C₁ of the driving and sensing electrodes 106 numbered P+1, P+2, P−1, or P−2. Furthermore, the touch pressure can also be detected by simultaneously comparing the second values C₂ and the first values C₁ of the driving and sensing electrodes 106 numbered P+1, P+2, P−1, and P−2 to improve accuracy.

The method of detecting a touch point and touch pressure has the following advantages. Since both the touch point and the touch pressure can be detected, and touch feedback can be provided by the detection of the touch pressure. Therefore, the touch device 10 may be suitable for game playing to enhance the realistic senses while playing the game.

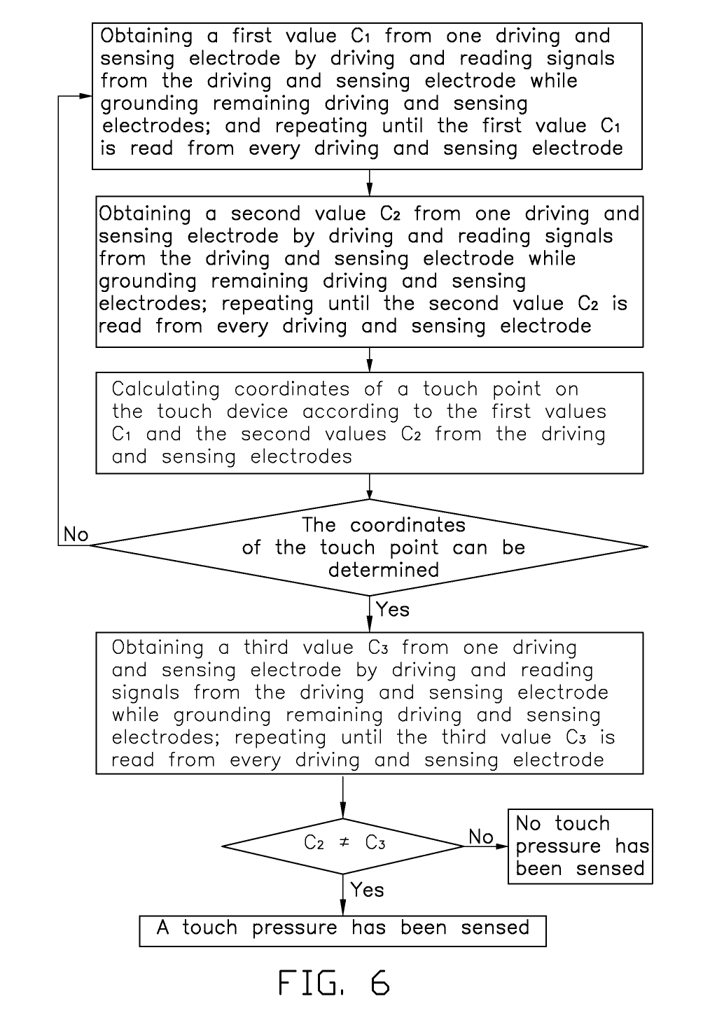

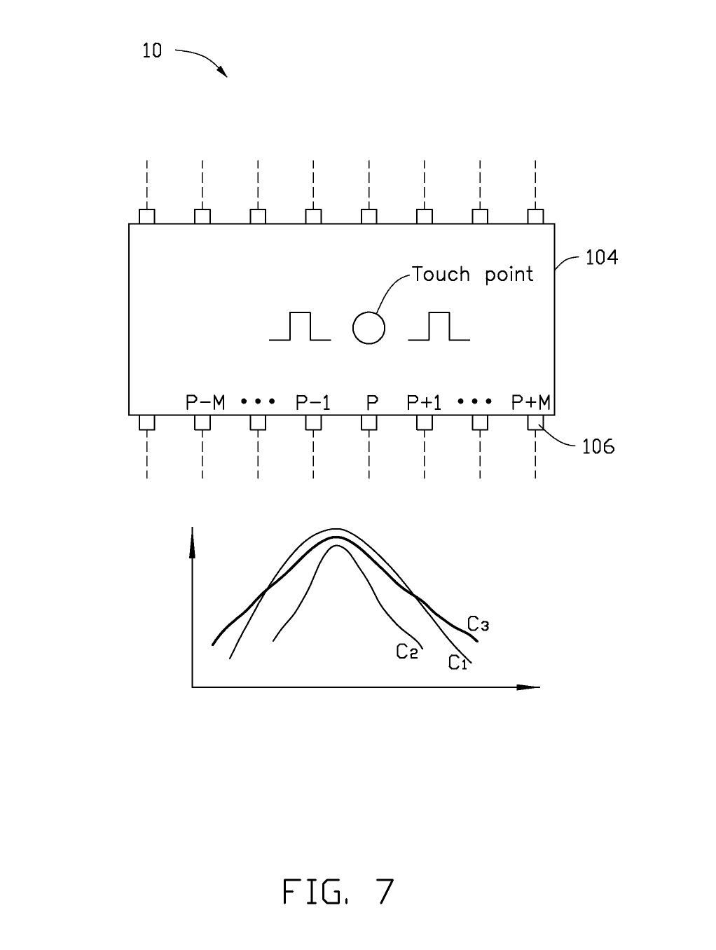

Referring to FIG. 6 and FIG. 7, a method of one embodiment of detecting the touch point and touch pressure on the touch device 10 includes following steps:

(S21), obtaining a first value C₁ from one driving and sensing electrode 106 by driving and reading signals from the driving and sensing electrode 106 while grounding remaining driving and sensing electrodes 106, and repeating until the first value C₁ is read from every driving and sensing electrode 106;

(S22), obtaining a second value C₂ from one driving and sensing electrode 106 by driving and reading signals from the driving and sensing electrode 106 while grounding remaining driving and sensing electrodes 106, and repeating until the second value C₂ is read from every driving and sensing electrode 106;

(S23), calculating coordinates of a touch point on the touch device according to the first values C₁ and the second values C₂ from the driving and sensing electrodes;

(S24), obtaining a third value C₃ from one driving and sensing electrode by driving and reading signals from the driving and sensing electrode while grounding remaining driving and sensing electrodes, and repeating until the third value C₃ is read from every driving and sensing electrode; and

(S25), determining whether there is touch pressure by comparing the first value C₁ and the third value C₃.

The touch point is sensed by comparing the first values C₁ and the second values C₂, thus the unintended “ghost point” may be avoided. Therefore, the accuracy of locating a touch point can be improved.

The touch point can be determined by comparing the second values C₂ with the first values C₁. When C₂=C₁, the touch point is intentional by a touching device. When C₂>C₁, the touch point is unintentional.

As an example, in the Step (S22), when there is a water droplet on the touch device 10, the water droplet can be grounded through the grounded driving and sensing electrodes 106, and the second values C₂ will be greater than the first values C₁. When the touch device 10 is touched by a finger, because the finger has already been grounded during obtaining the first values C₁, the second values C₂ will be equal to the first values C₁. Therefore, the touch point caused by the finger or the water droplet can be distinguished.

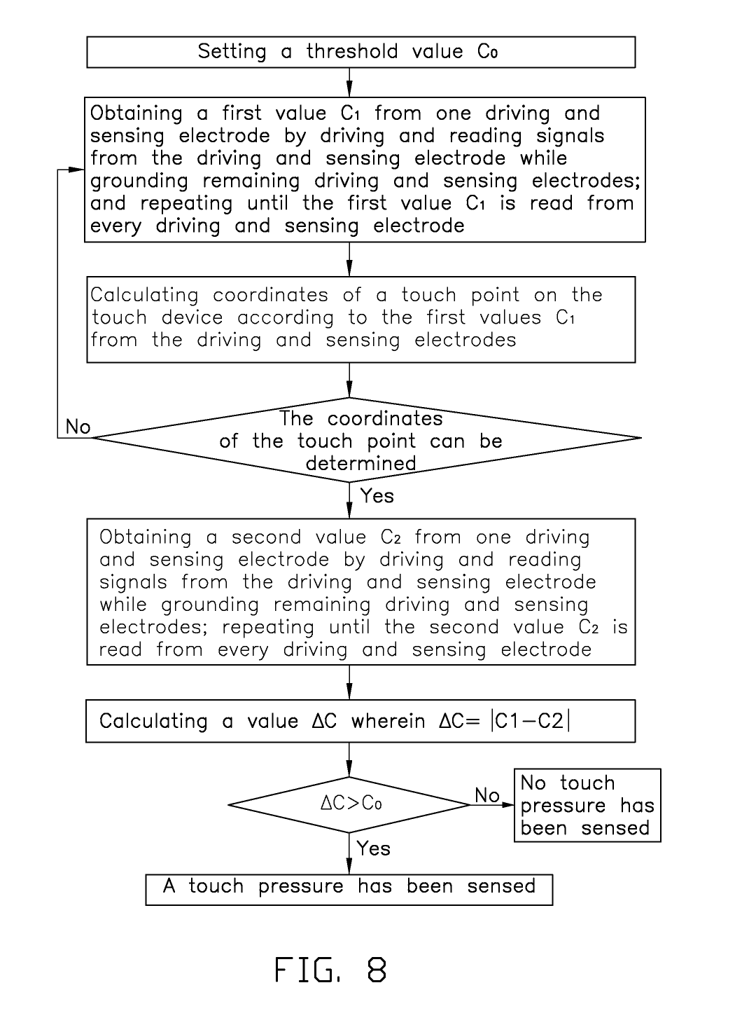

Referring to FIG. 8, a method of locating a touch point and sensing a touch pressure includes following steps:

(S31), presetting a threshold C₀;

(S32), obtaining a first value C₁ from one driving and sensing electrode 106 by driving and reading signals from the driving and sensing electrode 106 while grounding remaining driving and sensing electrodes 106, and repeating until the first value C₁ is read from every driving and sensing electrode 106;

(S33), obtaining a second value C₂ from one driving and sensing electrode 106 by driving and reading signals from the driving and sensing electrode 106 while grounding remaining driving and sensing electrodes 106, and repeating until the second value C₂ is read from every driving and sensing electrode 106;

(S34), calculating a value ΔC wherein ΔC=|C₁−C₂|; and

(S35), determining the touch pressure by comparing the plurality of difference values AC with the threshold C₀.

The threshold C₀ can be preset according to the accuracy requirements of the touch device 10. When the touch pressure F is weak, the change of distance d between the first conductive film 104 and the second conductive film 161 will be small. Thus the value AC will be small. Therefore, a proper threshold C₀ can be selected according to the accuracy requirements of sensing touch pressure.

In one embodiment, the threshold C₀ is defined as a difference between the first values C₁ and a plurality of values sensed by the driving and sensing electrodes 106 when a finger touches the touch panel but does not cause a change in distance between the first conductive film 104 and the second conductive film 161 of the touch module 14. When the value ΔC is greater than the threshold value C₀, the touch pressure can be sensed. While the value ΔC is smaller than the threshold value C₀, a touch pressure may not be sensed.

Furthermore, the touch pressure F can be calculated by the value ΔC. The touch pressure F varies with the change of the distance Δd between the first conductive film 104 and the second conductive film 161. Furthermore, Δd varies with the value ΔC. A relationship between the touch pressure F and value ΔC may be F∝ΔC, i.e., the greater the value ΔC, the greater the touch pressure F. Thus the touch pressure F can be calculated through the value ΔC.

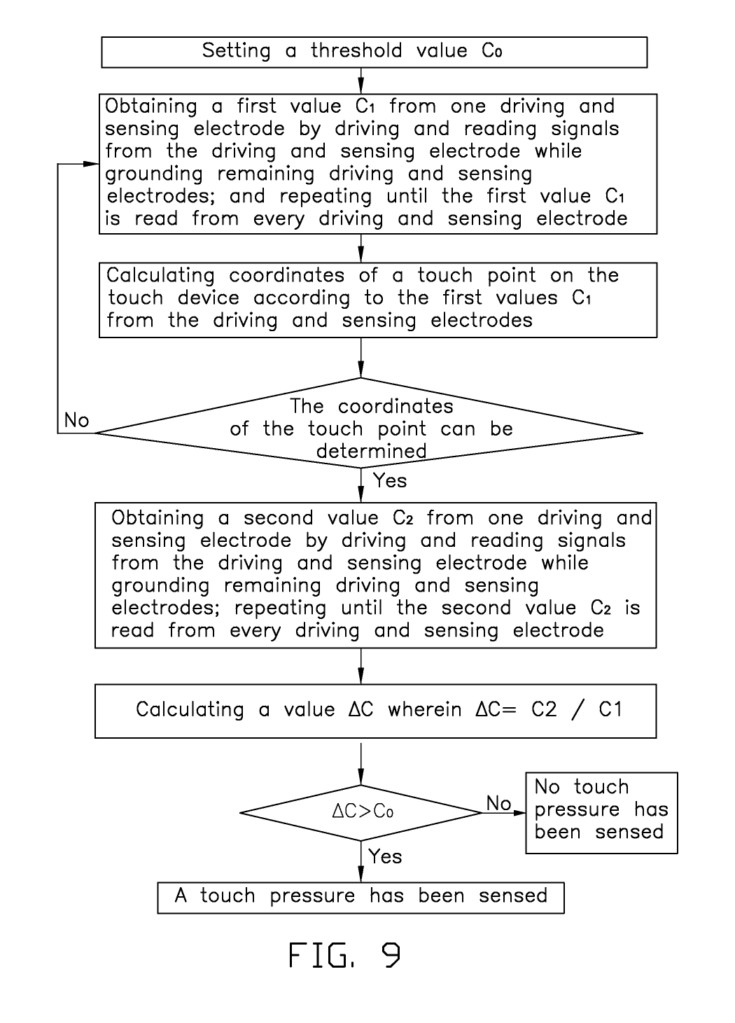

Referring to FIG. 9, a method of locating a touch point and sensing a touch pressure includes following steps:

(S41), presetting a threshold C₀;

(S42) obtaining a first value C₁ from one driving and sensing electrode 106 by driving and reading signals from the driving and sensing electrode 106 while grounding remaining driving and sensing electrodes 106; and repeating until the first value C₁ is read from every driving and sensing electrode 106;

(S43) obtaining a second value C₂ from one driving and sensing electrode 106 by driving and reading signals from the driving and sensing electrode 106 while grounding remaining driving and sensing electrodes 106; repeating until the second value C₂ is read from every driving and sensing electrode 106;

(S44) calculating a value ΔC wherein ΔC=C₂/C₁; and

(S45) determining the touch pressure by comparing the plurality of ratio ΔC with the threshold C₀.

The threshold value C₀ can be preset according to the accuracy requirements of the touch device 10. While touch pressure F is weak, the change of distance Δd between the first conductive film 104 and the second conductive film 161 will be small. Thus the value ΔC will be small. Therefore, a proper threshold C₀ can be selected according to the accuracy requirements of the sensing touch pressure.

In one embodiment, the threshold value C₀ satisfies 1≦C₀≦2, for example, C₀=1, 1.1, 1.2, or 1.5. While the ratio ΔC is greater than the threshold value C₀, the touch pressure can be sensed. When the ratio ΔC is smaller than the threshold value C₀, the touch pressure on the touch device 10 may not be sensed.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of locating a touch point and sensing a touch pressure on a touch device comprising:
providing a touch module comprising a first conductive film on a substrate, wherein the first conductive film defining a low electrical impedance in a direction D and a high electrical impedance in a direction H perpendicular with the D direction, and a plurality of first driving and sensing electrodes on at least one of two opposite sides of the D direction of the substrate;
forming a capacitive touch sensor by placing a second conductive film spaced from the first conductive film;
obtaining a first value C₁ from each of the plurality of driving and sensing electrodes by driving and reading signals from one of the plurality of driving and sensing electrodes while grounding remaining of the plurality of driving and sensing electrodes;
calculating coordinates of the touch point on the touch device according to the first values C₁ from the plurality of driving and sensing electrodes;
obtaining a second value C₂ from the each of the plurality of driving and sensing electrodes by repeating the step of obtaining the first value C₁; and
determining a touch pressure has been applied on the touch device if the first value C₁ and the second value C₂ of any of the plurality of driving and sensing electrodes are different.

2. The method of claim 1, comprising making the first conductive film comprising a carbon nanotube film which is free standing and transparent, the carbon nanotube film comprising carbon nanotubes substantially aligned in an alignment direction and end-to-end joined along the alignment direction.

3. The method of claim 2, wherein the carbon nanotubes in the carbon nanotube film are combined by van der Waals attractive force.

4. The method of claim 1, the steps of obtaining the first value C1 and the second value C2 comprises inputting an electric pulse signal through a driving integrated circuit to the driving and sensing electrode and reading a signal output form the driving and sensing electrode by a sensing integrated circuit while the remaining of the plurality of driving and sensing electrodes are grounded; and the coordinates of the touch point are calculated by the signal output from the driving and sensing electrodes.

5. The method of claim 1, wherein the first value C₁ and the second value C₂ are electrical capacity values read by each of the plurality of driving and sensing electrodes.

6. The method of claim 1, wherein the step of detecting the touch pressure comprises comparing the first value C1 with the second value C2 read from a same driving and sensing electrode.

7. The method of claim 1, wherein the step of detecting the touch pressure comprises comparing the first value C1 with the second value C2 read from each of the driving and sensing electrodes near the touch point.

8. The method of claim 7, wherein the driving and sensing electrode is near the touch point when the driving and sensing electrode is away from the touch point less than half of a total number of the driving and sensing electrodes; and the touch pressure is detected by comparing the first values C1 and the second value C2 of any of the driving and sensing electrode which is near the touch point.

9. A method of locating a touch point and sensing a touch pressure on a touch device comprising:
providing a touch module comprising a first conductive film on a substrate, wherein the first conductive film defining a low electrical impedance in a direction D and a high electrical impedance in a direction H perpendicular with the D direction, and a plurality of first driving and sensing electrodes on at least one of two opposite sides of the D direction of the substrate;
forming a capacitive touch sensor by placing a second conductive film spaced from the first conductive film;
obtaining a first value C₁ from each of the plurality of driving and sensing electrodes by driving and reading signals from one of the plurality of driving and sensing electrodes while grounding remaining of the plurality of driving and sensing electrodes;
obtaining a second value C₂ from the each of the plurality of driving and sensing electrodes by repeating the previous step, and calculating coordinates of the touch point on the touch device according to the first values C₁ and the second values C₂ from the plurality of driving and sensing electrodes;
obtaining a third value C₃ from the each of the plurality of driving and sensing electrodes by repeating the step of obtaining the first value C₁; and
determining a touch pressure has been applied on the touch device if the second value C₂ and the third value C₃ of any of the plurality of driving and sensing electrodes are different.

10. The method of claim 9, comprising
comparing the first value C₁ with the second value C₂ of any of the plurality of driving and sensing electrode, and
determining the touch pressure is negligible when the first value C₁ is not equal to the second value C₂.

11. A method of locating a touch point and determining a touch pressure on a touch device comprising:
providing a touch module comprising a first conductive film on a substrate, wherein the first conductive film defining a low electrical impedance in a direction D and a high electrical impedance in a direction H perpendicular with the D direction, and a plurality of first driving and sensing electrodes on at least one of two opposite sides of the D direction of the substrate;
forming a capacitive touch sensor by placing a second conductive film spaced from the first conductive film at a distance d;
setting a threshold value C₀;
obtaining a first value C₁ from each of the plurality of driving and sensing electrodes by driving and reading signals from one of the plurality of driving and sensing electrodes while grounding remaining of the plurality of driving and sensing electrodes;
calculating coordinates of the touch point on the touch device according to the first values C₁ from the plurality of driving and sensing electrodes;
obtaining a second value C₂ from the each of the plurality of driving and sensing electrodes by repeating the step of obtaining the first value C₁;
formulating a equation to compare the first value C₁ and the second value C₂ of each of the plurality of driving and sensing electrodes according, and calculating a value ΔC of each of the plurality of driving and sensing electrodes according to the equation; and
determining a touch pressure F has been applied on the touch device by comparing the value ΔC of each of the plurality of driving and sensing electrodes with the threshold value C₀.

12. The method of claim 11, the step of setting the threshold value C₀ comprises setting a nominal value read from the plurality of driving and sensing electrodes when a pointing device is completely in contact with the touch device but does not cause a change of the distance d between the first conductive film and the second conductive film; and setting the threshold value C₀ as an absolute difference between the nominal value and the first value C₁ from a driving and sensing electrode nearest the touch point.

13. The method of claim 11, wherein the equation is an absolute value of C₁−C₂.

14. The method of claim 13, the step of determining the touch pressure F comprises determining the touch pressure F has been applied on the touch device when the value AC of any of the plurality of driving and sensing electrodes is greater than the threshold value C₀.

15. The method of claim 11, the step of formulating the equation comprises correlating the value ΔC to be proportional to the touch pressure F.

16. The method of claim 15, wherein Δd is a change of the distance d between the first conductive film and the second conductive film; and the step of formulating the equation further comprises correlating the value ΔC to be proportional to Δd.

17. The method of claim 11, wherein the equation is a ratio of the second value C₂ to the first value C₁.

18. The method of claim 17, the step of determining the touch pressure F comprises determining the touch pressure F has been applied on the touch device when the value ΔC of any of the plurality of driving and sensing electrodes is greater than the threshold value C₀.

19. The method of claim 18, wherein the threshold value C₀ is between or equal to 1 and 2.
